(19) United States
(12) Patent Application Publication
(10) Pub. No.: US 2005/0233197 A1
(43) Pub. Date: Oct. 20, 2005

(54) Fuel-cell device, gas-injecting unit, and method for generating power using the fuel-cell device

(76) Inventor: Norikazu Nakayama, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/065,670

(22) Filed: Feb. 24, 2005

(30) Foreign Application Priority Data
Feb. 27, 2004 (JP) P2004-053414

(51) Int. Cl. H01M 8/04; B67D 5/00

(52) U.S. Cl. 429/34; 429/4; 429/10; 222/3

(57) ABSTRACT

A fuel-cell device according to the present invention includes a fuel-cell unit having a first and second flow channels and a cell for generating an electromotive force with the use of gases circulating in the first and second flow channels, and a gas-injecting unit disposed adjacent to the fuel-cell unit and injecting air into the first flow channel in the form of a pulsating flow. With this structure, the gas-injecting unit injects air into the first flow channel in the form of a pulsating flow to supply the air to the cell. When a vibrating plate is used as means for injecting the gas from the gas-injecting unit, the fuel-cell device can be low-profiled. In addition, boundary layers of air that are easily formed in the first flow channel or the retained air can be agitated to improve the power generation efficiency.

### BACKGROUND OF THE INVENTION

1. Field of the Invention

The present invention relates to fuel-cell devices generating power using predetermined gases, relates to gas-injecting units suitable for the fuel-cell devices, and relates to methods for generating power using the fuel-cell devices.

2. Description of the Related Art

The development of fuel-cell devices has advanced in view of applications of fuel-cell devices to automobiles such as electric vehicles or hybrid vehicles. In addition, such applications are not limited to those included above, and applications of the fuel-cell devices to light and small equipment, for example, portable equipment are in the research-and-development stage.

In general, a fuel-cell device generates power within a cell functioning as a generator when fuel gas is supplied to the cell. The cell includes, for example, an air electrode to which air is supplied, a fuel electrode to which a fuel, such as hydrogen, is supplied, and an electrolyte such as a proton conductor interposed between the air electrode and the fuel electrode so as to generate a chemical reaction.

In a typical fuel-cell device, a predetermined number of the above-described unit cells are stacked to produce a large electromotive force. With this structure, both fuel and air can be supplied from the side faces of the cells. However, the cells are not applicable to portable equipment since the weight and the volume of the entire cells are increased. The thickness of the power-generating module for the portable equipment is desirably several millimeters, which corresponds to the thickness of one cell.

Examples of such thin fuel-cell devices include a type passively supplying air through the use of natural convection without specific means for supplying air, and a type actively supplying air using means for supplying air such as a fan (for example, Japanese Unexamined Patent Application Publication No. 10-92456). The former type has a simple structure that can easily be downsized, and does not require additional power, which increases the power generation efficiency. However, the production of power is limited since the volume of supplied air is small. Accordingly, the latter type, having means for actively supplying air using, for example, a fan with moving vanes, can be a thin fuel-cell device generating practical power.

The device described in Japanese Unexamined Patent Application Publication No. 10-92456 employs a centrifugal fan that draws air from one direction along the rotational axis of the fan and that discharges the air in the direction orthogonal to the rotational axis. This structure requires some space in the direction of the rotational axis of the fan, and thus precludes the reduction in thickness. On the other hand, when a radial fan (for example, a fan having a cylindrical casing) is used, more space is required in the direction of the rotational axis of the fan compared with the centrifugal fan.

Moreover, an air-supplying device using a fan requires a wing area to maintain the air-supply performance. Furthermore, the shape is limited to an approximate square or a circle; there is little flexibility in terms of the shape of the rotational plane.

When the fan is arranged sufficiently remote from the cell and air is supplied from the fan through an appropriate flow channel, there are few constraints on the space adjacent to the cell. However, the channel resistance between the fan and the cell is increased, and a large fan is required to supply a sufficient volume of air. Furthermore, when the thin fuel-cell device is used as a detachable power-generating module, the fan cannot be arranged so as to be remote from the power-generating cell.

In addition, when air is supplied to the cell using the fan, the air generates a laminar flow circulating in the flow channel to the cell. As a result, boundary layers of air are formed in the vicinity of the electrode surface, and thus the air is retained on the electrode. This leads to an insufficient amount of air being supplied to the cell. Moreover, water formed during power generation by the cell sometimes remains in the flow channel, thus reducing the power generation efficiency. When the above-described fan is used, the retained water may be vaporized by the airflow of the fan. However, it is difficult to vaporize most of the water, and only the surface water can be vaporized in practice. In particular, when a small or thin cell is used, the flow channel supplying air to the cell is also narrow, causing the retention of water over the flow channel due to the viscosity of the water.

### SUMMARY OF THE INVENTION

Accordingly, it is an object of the present invention to provide a fuel-cell device having a minimized area even with a low profile and an enhanced power generation efficiency, to provide a gas-injecting unit suitable for the fuel-cell device, and to provide a method for generating power using the fuel-cell device.

To achieve the above-described object, a fuel-cell device according to the present invention includes a fuel-cell unit having a flow channel for circulating a predetermined gas; and a mechanism disposed adjacent to the fuel-cell unit, the mechanism injecting the gas in the form of a pulsating flow.

According to the present invention, the mechanism supplies the gas to, for example, a cell functioning as a power-generating portion such that the gas is injected in the form of a pulsating flow. As a result, boundary layers of gas that are easily formed in the flow channel or the retained gas can be agitated to improve the power generation efficiency. In addition, water that remains in the flow channel can be removed by physical pressure. This also leads to an improvement in the power generation efficiency. In the case with a known fan, the volume of air sent from the fan may be increased to remove the boundary layers or water by physical pressure, but this requires more power. In addition, a fan with moving vanes cannot be easily low-profiled or downsized.

Furthermore, according to the present invention, the mechanism injects the gas by vibrating, for example, a vibrating plate. This leads to a thin and small fuel-cell device having a minimized area.

According to the present invention, the predetermined gas may be air or a fuel other than air. In particular, the mechanism may inject air.

According to an embodiment of the present invention, the mechanism may include a housing having at least one opening, and a vibrator for injecting the gas contained inside the housing into the flow channel through the opening. With this structure, the pressure of the gas sent into the flow channel can be maximized so as to agitate the gas retained in the flow channel or to remove water retained in the flow channel.

In the present invention, a controlling section may control the vibration of the vibrator. In this case, the controlling section controls at least one of amplitude, frequency of vibration (driving frequency), and phase of the vibrator. In this manner, the power generation capacity of the fuel-cell device or the volume of air supplied depending on the power generation efficiency and the like can be optimized.

According to an embodiment of the present invention, the vibrator may include a first surface facing the exterior of the housing and a second surface facing the interior of the housing. According to the present invention, the gas is injected using most of the total volume of the housing. Accordingly, the volume of injected gas is increased to improve the power generation efficiency.

According to an embodiment of the present invention, the housing may include a plurality of chambers partitioned by the vibrator, said at least one opening in the housing may include a plurality of openings connecting the chambers with the exterior of the housing, and the vibrator may inject the gas contained inside the chambers through the openings. With this structure, for example, when the fuel-cell unit includes stacked cells, the gas can be supplied to flow channels of the stacked cells. The vibrator may include one or more vibrators. Moreover, one chamber may include one or more openings. The same applies to the following.

According to an embodiment of the present invention, the chambers may have substantially the same volumes, and the spaces between the vibrator and each of the openings may be substantially the same. As a result, the aerodynamic characteristics of the gas inside the chambers become symmetrical, and a constant volume of gas is injected from the openings. Thus, the volume of gas supplied to the cells, for example, is constant, and the power generation efficiency is improved.

According to an embodiment of the present invention, the fuel-cell unit may include an inlet for introducing the gas injected from the mechanism to the flow channel, the inlet facing the opening; and the gap between the opening and the inlet may be one time to ten times larger than the width of the opening. When the gas is injected from the opening, the gas pressure in the vicinity of the injected gas is reduced and the gas around the injected gas is engulfed. In other words, the flow of the injected gas and that of the circumambient gas generate vortexes. Thus, the flow of the gas injected from the opening is in the form of vortexes. According to the present invention, if the gap is more than ten times larger than the width of the opening, the vortexes become too large and prevent the injected gas from flowing into the inlet at the required rate. On the contrary, if the gap is smaller than the width, the injected gas flow cannot engulf the circumambient gas to prevent the vortexes from being generated. In particular, the housing and the fuel-cell unit are preferably arranged such that the gap is two times to five times larger than the width of the opening. The most appropriate value for the gap is also dependent on the amplitude value of the vibrator, i.e. the volume of injected gas. However, with the structure according to the present invention, the injected gas can efficiently flow into the inlet at the required rate.

The profile of the opening is not particularly limited. When the opening is a square or a rectangle close to a square, the width means the length of one side or the diagonal line of the rectangle.

According to an embodiment of the present invention, the fuel-cell unit may include an inlet for introducing the gas injected from the mechanism to the flow channel, the inlet facing the opening; and the opening area of the opening may be smaller than that of the inlet. As a result, the volume of gas sent into the inlet can be increased, and the gas can be efficiently supplied to enhance the power generation efficiency.

According to an embodiment of the present invention, the fuel-cell unit may include an inlet for introducing the gas injected from the mechanism to the flow channel, the inlet facing the openings; and the total opening area of the openings may be smaller than the opening area of the inlet. According to the present invention, the gas injected from the openings can be efficiently sent into, for example, one inlet to enhance the power generation efficiency.

According to an embodiment of the present invention, the vibrator may include a vibrating plate having a first surface substantially perpendicular to the vibrating direction of the vibrator and a second surface substantially parallel to the first surface, and at least one coil attached to at least one of the first surface and the second surface; and the mechanism may include at least one permanent magnet opposing said at least one coil. As a result, a thin and small fuel-cell device having a power generation efficiency equal to or higher than that in the case with the known fan can be provided.

A gas-injecting unit according to the present invention includes at least one permanent magnet; a vibrating plate having a first region and a second region surrounding the first region, capable of injecting gas in the form of a pulsating flow generated by the pressure of the vibration when the vibrating plate vibrates; at least one coil arranged in the first region; and a supporting body supporting the permanent magnet and the vibrating plate such that the vibrating plate vibrates by the interaction between a magnetic field generated by the permanent magnet and that generated when the coil is energized.

According to the present invention, vortexes are generated by vibrating the vibrating plate. When the gas-injecting unit is applied to a fuel-cell device, for example, the vortexes can be supplied to the flow channel for circulating the gas in the fuel-cell device. Therefore, boundary layers of gas that are easily formed in the flow channel or the retained gas can be agitated to improve the power generation efficiency. Moreover, water that remains in the flow channel can be removed by physical pressure. This also leads to an improvement in the power generation efficiency. Furthermore, a fuel-cell device that is thinner and smaller than the known fan with moving vanes can be produced.

In the present invention, the term region means a three-dimensional area. When the coil is arranged in the region, the coil is naturally inside the region, and can also be on the vibrating plate.

According to an embodiment of the present invention, the Young's modulus of the second region may be lower than that of the first region. As a result, motion of the second region without the coil can be larger than that of the first region when the vibrating plate vibrates. In addition, when the Young's modulus of the first region having the coil is higher than that of second region, the vibrating plate can stably vibrate so as to inject a required volume of gas.

According to an embodiment of the present invention, the first region may be composed of a resin selected from an epoxy resin, a polyimide resin, a polyetherimide resin, and a polyethylene-terephthalate resin; and the second region may be composed of butyl rubber. With this structure, the Young's modulus of the first region and that of the second region are different from each other.

According to an embodiment of the present invention, the first region and the second region of the vibrating plate may be composed of the same material, and the second region may be partially recessed in the same direction as the vibrating direction of the vibrator so as to form a groove. Even when the first region and the second region are composed of the same material, the flexural rigidity of the second region can be reduced compared with that of the first region by forming a groove in the second region. Thus, the vibrating plate can stably vibrate.

According to an embodiment of the present invention, the coil may be of a planar type wound in a plane perpendicular to the vibrating direction of the vibrator, and the groove may be arranged in the plane in a helical fashion. For example, a lead wire extending from the coil may be arranged in a helical fashion without crossing the groove. Therefore, breakage of the lead wire can be avoided even when the vibrating plate vibrates.

According to an embodiment of the present invention, the gas-injecting unit may further include a lead wire electrically connected to the coil and detached from the gas-injecting unit. The lead wire is detached from the gas-injecting unit so as not to come into contact with the supporting body or the vibrating plate. As a result, breakage of the lead wire can be avoided even when the vibrating plate vibrates.

According to an embodiment of the present invention, the vibrating plate may include a first surface substantially perpendicular to the vibrating direction of the vibrating plate, a second surface substantially parallel to the first surface, and a hole extending from the first surface to the second surface; and said at least one coil may include a first coil arranged in the first surface and a second coil electrically connected to the first coil through the hole. If the winding directions of both the first coil and the second coil are determined such that the magnetic lines of the force generated by the coils are oriented in the same direction, for example, the electromagnetic force can be increased. Thus, the conversion efficiency from the electrical energy supplied to the coils into the vibrational energy of the vibrating plate can be enhanced.

According to an embodiment of the present invention, said at least one permanent magnet may include a first permanent magnet opposing the first coil, and a second permanent magnet opposing the second coil and facing the first permanent magnet having the same pole. As a result, the electromagnetic force is increased to enhance the conversion efficiency from the electrical energy supplied to the coils into the vibrational energy of the vibrating plate.

According to an embodiment of the present invention, said at least one permanent magnet may include a plurality of permanent magnets arranged along a plane substantially perpendicular to the vibrating direction of the vibrating plate such that the directions of magnetic fields generated at two adjacent permanent magnets are opposite, and said at least one coil may include a plurality of coils arranged corresponding to the permanent magnets. As a result, the electromagnetic force can be increased to enhance the conversion efficiency from the electrical energy supplied to the coils into the vibrational energy of the vibrating plate.

According to an embodiment of the present invention, the supporting body may contain a magnetic material in the vicinity of the permanent magnet. Magnetic circuits can be formed of this magnetic material in the supporting body so as to increase the electromagnetic force and to enhance the conversion efficiency from the electrical energy supplied to the coils into the vibrational energy of the vibrating plate.

According to an embodiment of the present invention, the supporting body may be a housing having at least one opening, and the vibrating plate may inject the gas contained inside the housing through the opening when the vibrating plate vibrates. As a result, vortexes are generated by injecting the gas from the opening.

According to an embodiment of the present invention, the housing may include a plurality of chambers partitioned by the vibrating plate, said at least one opening may include a plurality of openings connecting the chambers with the exterior of the housing, and the vibrating plate may inject the gas contained inside the chambers through the openings. As a result, the gas can be injected from, for example, the respective openings of two chambers using a single vibrating plate.

A method for generating power according to the present invention, the method generating power using a fuel-cell device having a flow channel for circulating a predetermined gas, includes the steps of injecting the gas in the form of a pulsating flow into the flow channel, and generating power through the use of the gas circulating in the flow channel.

According to the present invention, since the gas is supplied to, for example, the cell of the fuel-cell device such that the gas is injected into the flow channel in the form of a pulsating flow, boundary layers of gas that are easily formed in the flow channel or the retained gas can be agitated to improve the power generation efficiency. Moreover, water that remains in the flow channel can easily be removed. This also leads to an improvement in the power generation efficiency.

### BRIEF DESCRIPTION OF THE DRAWINGS

FIG. 1 is a perspective view illustrating a fuel-cell device according to an embodiment of the present invention;

FIG. 2 is an exploded perspective view of a fuel-cell unit shown in FIG. 1;

FIG. 3 is a cross-sectional view taken along line III-III in FIG. 1;

FIG. 4 is a plan view of a vibrator;

FIG. 5 is a graph illustrating the relationship between current density and electromotive force of the fuel-cell device according to the embodiment;

FIG. 6 is a graph illustrating the experimental results of a continuous operation of the fuel-cell device according to the embodiment;

FIG. 7 is a cross-sectional view illustrating a gas-injecting unit according to another embodiment;

FIG. 8 is a cross-sectional view taken along line VIII-VIII in FIG. 7;

FIG. 9 is a cross-sectional view illustrating a gas-injecting unit according to yet another embodiment;

FIG. 10 is a cross-sectional view taken along line X-X in FIG. 9;

FIG. 11 is a cross-sectional view illustrating a gas-injecting unit according to yet another embodiment;

FIG. 12 is a cross-sectional view illustrating a gas-injecting unit according to yet another embodiment;

FIG. 13 is a cross-sectional view illustrating a gas-injecting unit according to yet another embodiment;

FIG. 14 is a perspective view illustrating a gas-injecting unit according to yet another embodiment;

FIG. 15 is a cross-sectional view of the gas-injecting unit shown in FIG. 14; and

FIG. 16 is a cross-sectional view illustrating a gas-injecting unit according to yet another embodiment.

### DESCRIPTION OF THE PREFERRED EMBODIMENTS

Embodiments of the present invention will now be described with reference to the drawings.

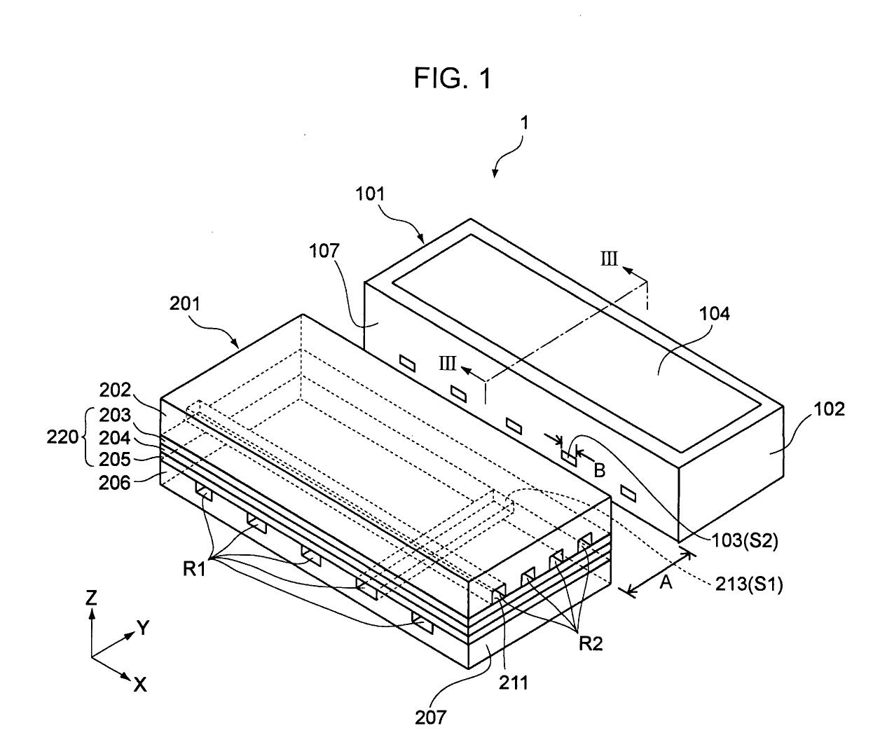

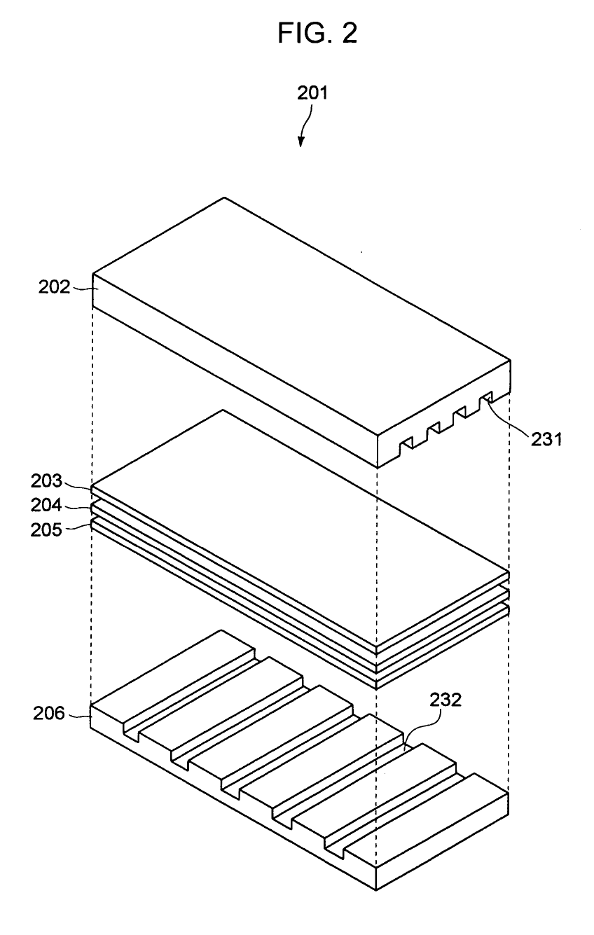

FIG. 1 is a schematic perspective view illustrating a fuel-cell device according to one embodiment of the present invention, and FIG. 2 is an exploded perspective view of a fuel-cell unit of the fuel-cell device.

With reference to FIG. 1, a fuel-cell device 1 according to this embodiment includes a fuel-cell unit 201 for generating an electromotive force and a gas-injecting unit 101 injecting gas into the fuel-cell unit 201. The gas-injecting unit 101 and the fuel-cell unit 201 are arranged with a predetermined gap A therebetween. Hydrogen-supplying means (not shown) is disposed adjacent to a side face 207 of the fuel-cell unit 201 to supply hydrogen fuel to the fuel-cell unit 201. At least the fuel-cell unit 201 and the gas-injecting unit 101 are mounted on, for example, a circuit board (not shown).

As shown in FIGS. 1 and 2, a lamination of a first pyroelectric separator 202 for hydrogen, a first electrode 203 for hydrogen, a proton conductor 204, a second electrode 205 for oxygen, and a second pyroelectric separator 206 for oxygen forms the fuel-cell unit 201. The first electrode 203, the proton conductor 204, and the second electrode 205 form a cell 220. The first pyroelectric separator 202 has grooves 231 functioning as flow channels R2 for hydrogen, and the second pyroelectric separator 206 has grooves 232 functioning as flow channels R1 for air. The flow channels R1 and R2 are orthogonal to each other. In regions where the flow channels R1 and R2 intersect with each other, hydrogen and oxygen are supplied to the proton conductor 204 through many pores (not shown) formed in the first electrode 203 and the second electrode 205. Thus, a required electromotive force is generated between the first electrode 203 and the second electrode 205.

On the other hand, a plurality of openings 103 each having a width B and an opening area S2 is formed in a front surface 107 of the gas-injecting unit 101 along the longitudinal direction of the gas-injecting unit 101. For example, the openings 103 oppose inlets 213 of the flow channels R1, and the number of openings 103 is the same as that of the inlets 213. The opening area S1 of each inlet 213 is larger than the opening area S2 of each opening 103. The gas-injecting unit 101 and the fuel-cell unit 201 are disposed such that the gap A between the openings 103 and the inlets 213 is between one and ten times larger than the width B of the openings 103.

In this embodiment, the openings 103 are rectangular, and the long side of the openings 103 is defined as the width B. However, the profile of the openings is not limited to a rectangle, and may be a square, a rectangle close to a square, or a circle.

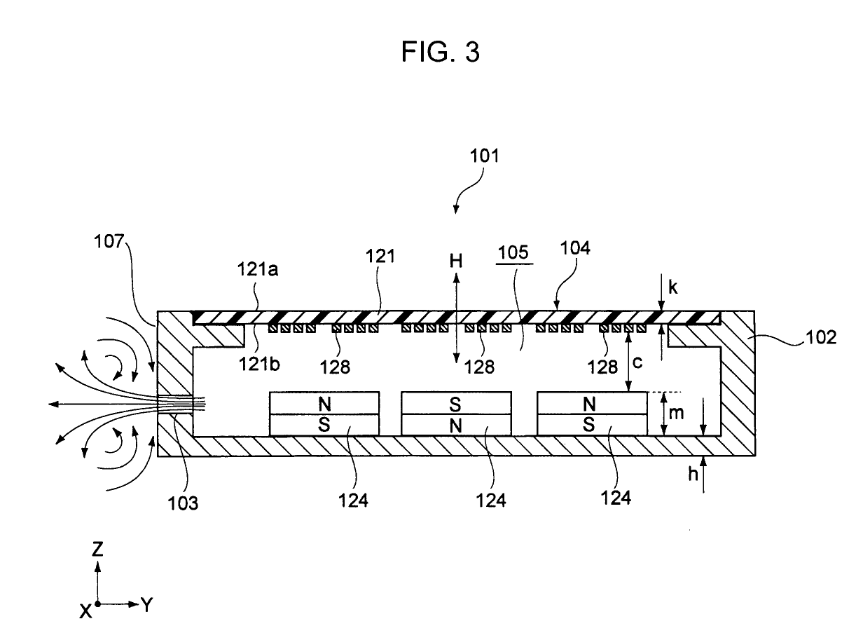

FIG. 3 is a cross-sectional view of the gas-injecting unit 101 taken along line III-III in FIG. 1.

With reference to FIG. 3, the gas-injecting unit 101 includes a hollow housing 102 forming an outer frame. The interior and the exterior of the housing 102 communicate with each other through the openings 103. A vibrator 104 capable of vibrating in the H direction is attached to the top of the housing 102. The vibrator 104 is formed of, for example, a vibrating plate 121 and a plurality of planar coils 128. The vibrating plate 121 is composed of, for example, an insulating material such as a resin. The planar coils 128 are attached to, for example, a back surface 121b of the vibrating plate 121 facing a chamber 105. A top surface 121a of the vibrating plate 121 faces the exterior of the housing 102.

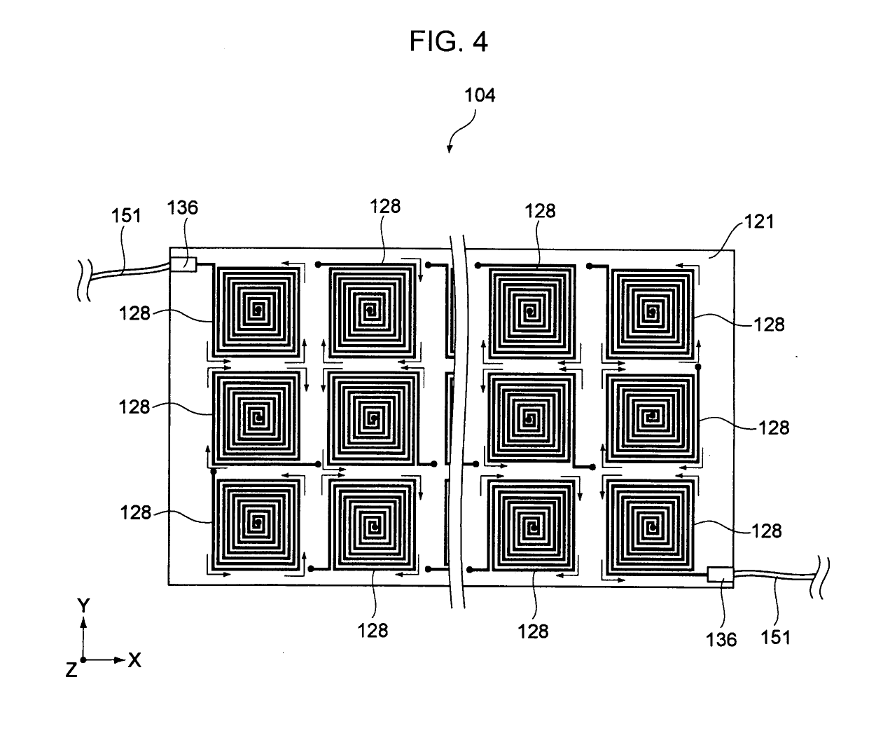

FIG. 4 is a plan view of the vibrator 104. The planar coils 128 are disposed on the vibrating plate 121 by nine in the longitudinal direction (X direction) and by three in the lateral direction (Y direction) at approximately regular intervals. The planar coils 128 are electrically connected to each other in series. The planar coils 128 may be embedded in the vibrating plate 121. Both ends of the linked planar coils 128 are connected to respective electrodes 136, and the electrodes 136 are connected to respective driving units (not shown) so as to drive the planar coils 128 via lead wires 151. Permanent magnets 124 are disposed at positions each opposing one planar coil 128. The permanent magnets 124 are attached to, for example, the bottom portion of the housing 102.

With this structure, the vibrator 104 vibrates in the H direction due to an electromagnetic force generated when an alternating voltage, for example, is applied to the planar coils 128. In other words, the housing 102 supports the permanent magnets 124 and the vibrating plate 121 such that the vibrating plate 121 vibrates by the interaction between a magnetic field generated by the permanent magnets 124 and that generated when the planar coils 128 are energized.

For example, the permanent magnets 124 are preferably disposed such that the centers thereof are collinear with those of the respective planar coils 128 opposing the permanent magnets 124. Thus, the conversion efficiency from the electrical energy supplied to the coils into the vibrational energy of the vibrator 104 can be greatly enhanced.

Moreover, the permanent magnets 124 and the planar coils 128 are disposed with a predetermined space c therebetween. When the space c is too small, the vibrator 104 may come into contact with the permanent magnets 124. Accordingly, the amplitude of the vibrator 104 cannot be increased. In addition, since the horizontal component of the magnetic field is reduced, the energy conversion efficiency described above is also reduced. On the contrary, when the space c is too large, the amplitude of the vibrator 104 can be increased. However, since the magnetic flux density in the positions of the planar coils 128 is reduced, the energy conversion efficiency is also reduced.

In a preferred embodiment of the present invention, two adjacent permanent magnets 124 are disposed such that the directions of the permanent magnetic fields are opposite to each other. As a result, the magnetic flux density in the Y direction is increased to enhance the energy conversion efficiency. In addition, in order to coordinate the directions of the magnetic fields with the permanent magnets 124 disposed as above, the planar coils 128 are wound such that the directions of the magnetic fields generated at two adjacent coils when a voltage is applied thereto are opposite to each other. That is to say, the planar coils 128 are wound and arranged such that the directions of the electric currents passing through two adjacent planar coils 128 shown in FIG. 4 are opposite to each other.

The size of the gas-injecting unit 101 is determined as follows, for example. As shown in FIG. 3, when the thickness h of the bottom portion of the housing 102, the thickness m of the permanent magnets 124, the space c between the permanent magnets 124 and the planar coils 128, and the thickness k of the vibrating plate 121 are all approximately 0.5 mm, the thickness of the gas-injecting unit 101 is approximately 2 mm. Thus, the resultant gas-injecting unit 101 can be made thinner. The thickness of the permanent magnets 124 can be reduced to 0.5 mm by using, for example, samarium-cobalt (SmCo) magnets.

Operations of the gas-injecting unit 101 having the above-described structure and a method for generating power using the fuel-cell device 1 will now be described.

When an alternating voltage, for example, is applied to the planar coils 128, the vibrator 104 vibrates in the H direction. In FIG. 3, when the vibrator 104 moves downwards, the air pressure inside the chamber 105 is increased to inject the air inside the chamber 105 to the outside through the openings 103. When the air is injected from the openings 103, the air pressure in the vicinity of the injected air is reduced and the air around the injected air is engulfed. In other words, the flow of the injected air and that of the circumambient air generate vortexes. Thus, the flow of the air injected from the openings 103 is in the form of vortexes. The vortexes are intermittently generated outside the housing 102, and are remote from each other by a distance corresponding to the product of the speed of the vortexes and the vibrational period of the vibrator 104.

As described above, the gap A between the openings 103 and the inlets 213 is between one and ten times larger than the width B of the openings 103. If the gap A is more than ten times larger than the width B of the openings 103, the vortexes become too large to prevent the injected air from flowing into the inlets 213 at the required rate. On the contrary, if the gap A is smaller than the width B, the injected airflow cannot engulf the circumambient air to prevent the vortexes from being generated. Specifically, the gap A is preferably two times to five times larger than the width B of the openings 103.

The most appropriate value for the gap A is also dependent on the amplitude value of the vibrator 104, i.e. the volume of gas injected, and is limited by the thickness or the mechanical strength of the cell. However, the injected air can efficiently flow into the inlets 213 at the required rate by setting the gap A as above.

In addition, as described above, the opening area S2 of the openings 103 is smaller than the opening area S1 of the inlets 213. Accordingly, the volume of air flowing into the inlets 213 can be increased to a maximum so as to provide an efficient air supply. As a result, the efficiency of power generation can be enhanced.

In FIG. 3, when the vibrator 104 moves upwards, the air pressure inside the chamber 105 is decreased to allow the air outside the housing 102 flow into the chamber 105 through the openings 103. Since the above-described vortexes also engulf the circumambient air, the volume of air flowing into the chamber 105 is less than that flowing out by the vortexes. Therefore, the vibration of the vibrator 104 causes an air supply from the openings 103 at a pulsative rate in the traveling direction. As a result, the power generation efficiency of the fuel-cell unit is improved compared with the case where a stationary airflow with a constant volume of air is supplied.

Specifically, the air injected from the openings 103 is sent into the flow channels R1 of the fuel-cell unit 201, and thus an electromotive force is generated in the cell 220 as a result of the supplied oxygen and hydrogen. The air sent into the flow channels R1 of the fuel-cell unit 201 can agitate boundary layers of air that are easily formed in the flow channels R1 or air that remains on the surfaces of the first electrode 203 and the like to improve the power generation efficiency. In addition, water that remains in the flow channels R1 can be removed by physical pressure. This also leads to an improvement in the power generation efficiency.

According to this embodiment, the vibrator 104 may be attached at a higher position in the housing 102 to use a larger volume of the housing 102 for the injection of gas. Accordingly, the volume of injected gas can be increased to improve the power generation efficiency of the fuel-cell device 1.

Experimental results of electromotive force of the fuel-cell device 1 according to this embodiment will now be described.

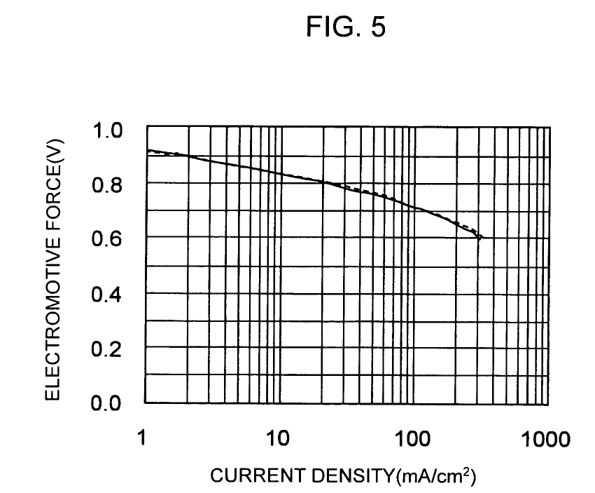

FIG. 5 is a graph illustrating the relationship between current density and electromotive force. A solid line shows the electromotive force of the fuel-cell device 1 according to this embodiment, and a broken line shows that of a known fuel-cell device using a fan with moving vanes. The electromotive forces in the experimental results are expressed per one cell. These experimental results show that the electromotive force of the fuel-cell device 1 is slightly larger than that of the known fuel-cell device in a region with a low current density (1 to 10 (mA/cm²)). Thus, the fuel-cell device 1 can generate substantially the same amount of electromotive force as in the known fuel-cell device, although the fuel-cell device 1 is much thinner and smaller than the known fuel-cell device.

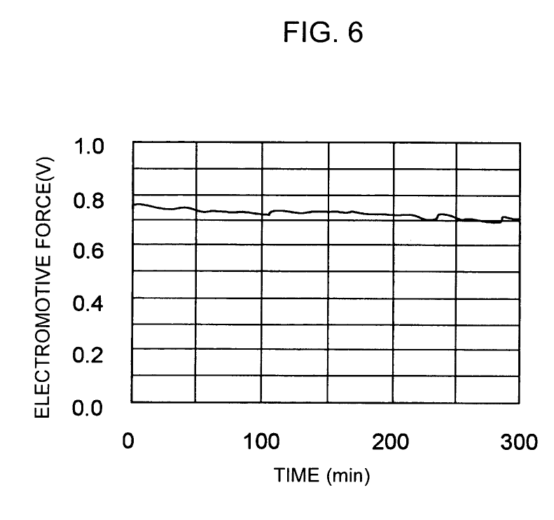

FIG. 6 is a graph illustrating the experimental results of a continuous operation of the fuel-cell device 1. The graph shows changes in the electromotive force of the fuel-cell device 1 with time when the fuel-cell device 1 is operated under a constant current load. These experimental results show that stable power is generated over a long period of time.

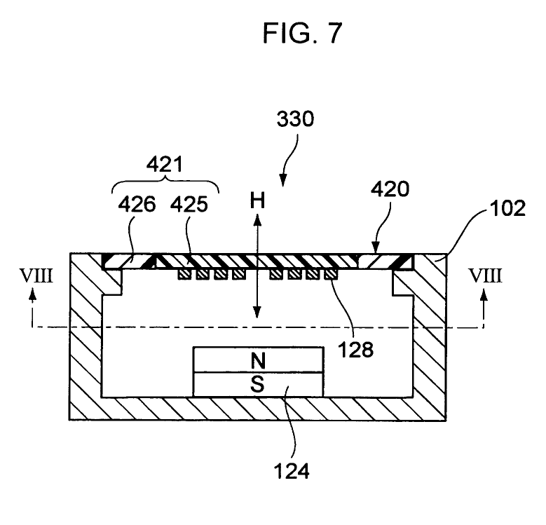

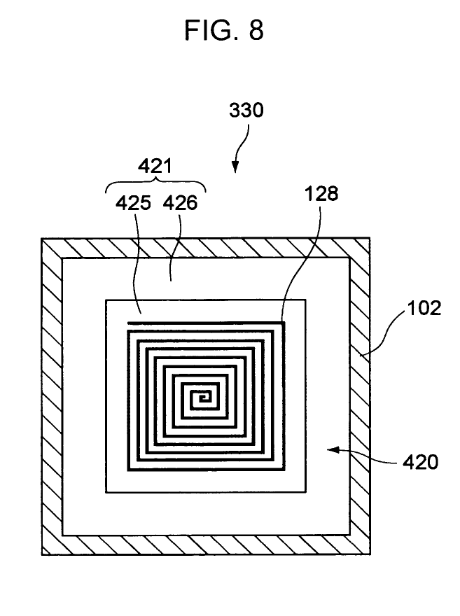

FIG. 7 is a cross-sectional view illustrating a gas-injecting unit according to another embodiment, and FIG. 8 is a cross-sectional view taken along line VIII-VIII in FIG. 7. Descriptions of the same components and functions of the gas-injecting unit 101 described in the above embodiment will be simplified or omitted, and only differences will be focused on. Similarly, descriptions of gas-injecting units described later will also focus only on differences.

A gas-injecting unit 330 includes a vibrator 420 attached to a housing 102 of the gas-injecting unit 330 such that the vibrator 420 can vibrate in the H direction. A vibrating plate 421 of the vibrator 420 has a first region 425 containing a planar coil 128 and a second region 426 surrounding the first region 425. The planar coil 128 may be, for example, embedded in the second region 426, or disposed on a top surface of the vibrating plate 421 such that the planar coil 128 faces the exterior of the housing 102.

The first region 425 is mainly composed of a resin such as an epoxy resin, a polyimide resin, a polyetherimide resin, or a polyethylene-terephthalate resin. The second region 426 is mainly composed of butyl rubber. Accordingly, the Young's modulus of the second region 426 is lower than that of the first region 425. As a result, motion of the second region 426 without the planar coil 128 can be larger than that of the first region 425 when the vibrating plate 421 vibrates. In addition, since the Young's modulus of the first region 425 having the planar coil 128 is higher than that of second region 426, the vibrating plate 421 can stably vibrate to inject the required volume of air.

No openings for gas injection are formed in the housing 102 of the gas-injecting unit 330. However, openings may be formed as in the case of the gas-injecting unit 101. Even if no openings are formed in the housing, gas can be supplied to the gas inlets of the fuel-cell unit by, for example, arranging the vibrator 420 so as to oppose the gas inlets.

In this embodiment, only one planar coil is provided in the gas-injecting unit, and the shape of the housing is substantially square as shown in FIG. 8 for ease of interpretation. However, the gas-injecting unit 330 may have a rectangular housing and a plurality of planar coils 128 as in the gas-injecting unit 101.

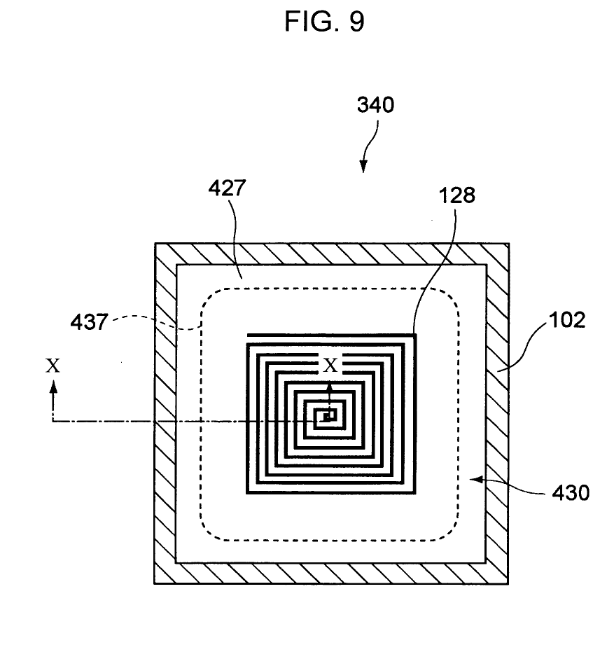

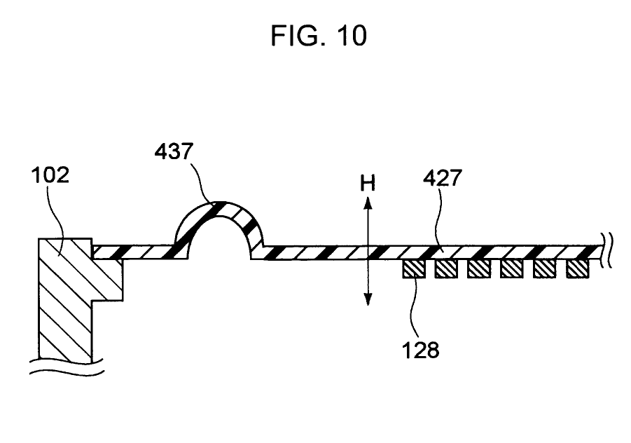

FIG. 9 is a cross-sectional view illustrating a gas-injecting unit according to another embodiment, and FIG. 10 is a cross-sectional view taken along line X-X in FIG. 9. A gas-injecting unit 340 includes a vibrator 430. As shown in FIG. 10, a vibrating plate 427 of the vibrator 430 is partially recessed in the H direction, i.e. in the vibrational direction of the vibrating plate 427, to form a groove 437. With this structure, the flexural rigidity at the groove 437 can be reduced to achieve stable vibration of the vibrator 430.

In this embodiment, a lead wire (not shown) extending from a planar coil 128 may be detached from the gas-injecting unit 340. Accordingly, the lead wire does not cross the groove 437. That is to say, when the lead wire is attached to, for example, the vibrating plate 427 so as to cross the groove 437, the lead wire is broken when the vibrator 430 vibrates; however, such a problem can be avoided by this embodiment.

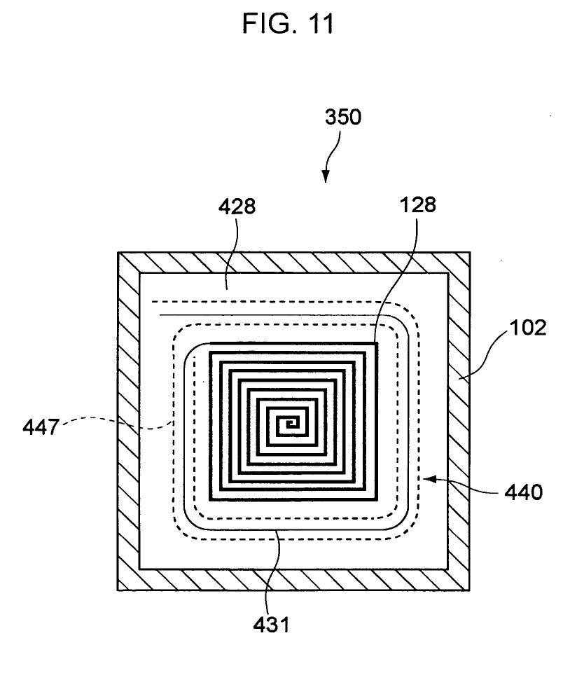

FIG. 11 is a cross-sectional view illustrating a gas-injecting unit according to another embodiment. A helical groove 447 is formed, for example, on the surface of a vibrating plate 428 around a planar coil 128. Accordingly, a helical lead wire 431 extending from the planar coil 128 may be arranged without crossing the groove 447. Therefore, breakage of the lead wire 431 can be avoided even when the vibrating plate 428 vibrates.

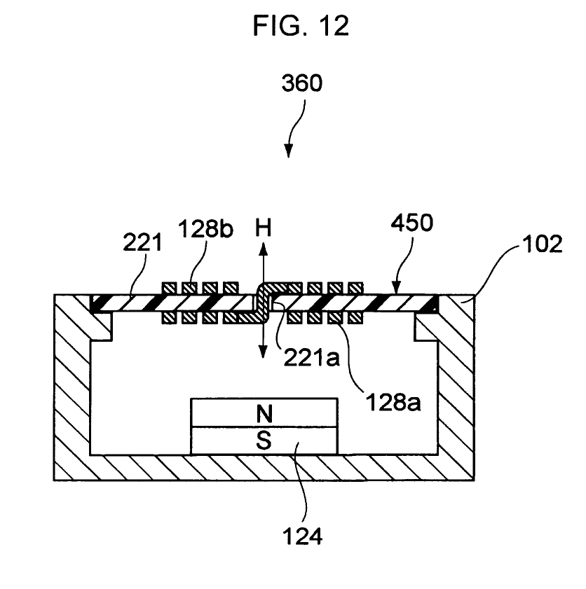

FIG. 12 is a cross-sectional view illustrating a gas-injecting unit according to another embodiment. A gas-injecting unit 360 includes a vibrating plate 221, for example, having a planar coil 128a and a planar coil 128b attached to respective surfaces of the vibrating plate 221. The vibrating plate 221 has a through hole 221a bored at the approximate center thereof. The planar coils 128a and 128b are electrically connected to each other via the through hole 221a. The winding directions of the coils are determined, for example, such that the magnetic lines of the force generated by the planar coils 128a and 128b are oriented in the same direction. In this case, the number of turns is increased for the same area of one planar coil, and thus the electromagnetic force can be increased. Thus, the conversion efficiency from the electrical energy supplied to the planar coils 128a and 128b into the vibrational energy of the vibrator 221 can be enhanced.

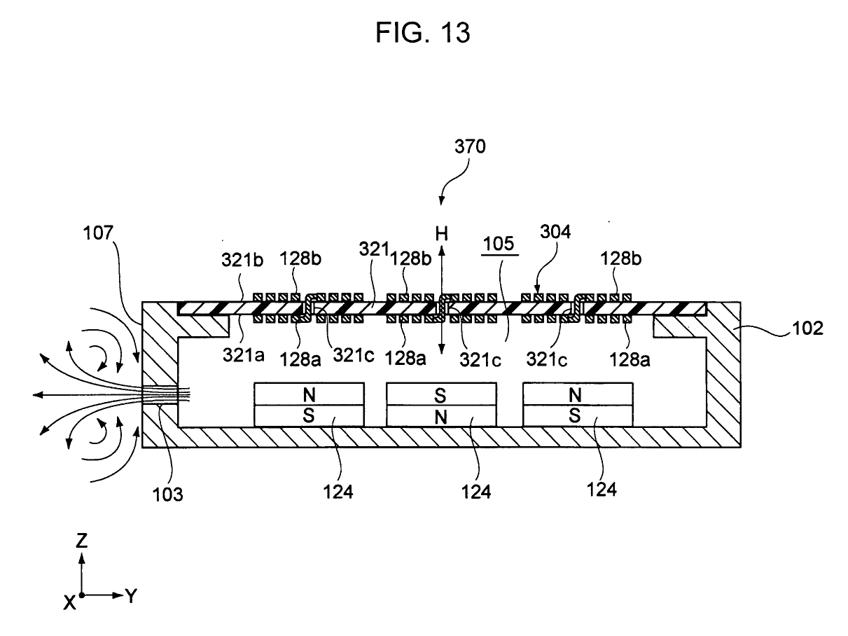

FIG. 13 is a cross-sectional view illustrating a gas-injecting unit according to another embodiment. A gas-injecting unit 370 includes a vibrating plate 321, instead of the vibrating plate 121 of the gas-injecting unit 101 shown in FIG. 3, having planar coils 128a and planar coils 128b attached to a surface 321a and a surface 321b of the vibrating plate 321, respectively. The planar coils 128a are electrically connected to the respective planar coils 128b via through holes 321c. According to this arrangement, a plurality of coil sets provided in the gas-injecting unit further enhances the conversion efficiency into the vibrational energy of the vibrating plate 321.

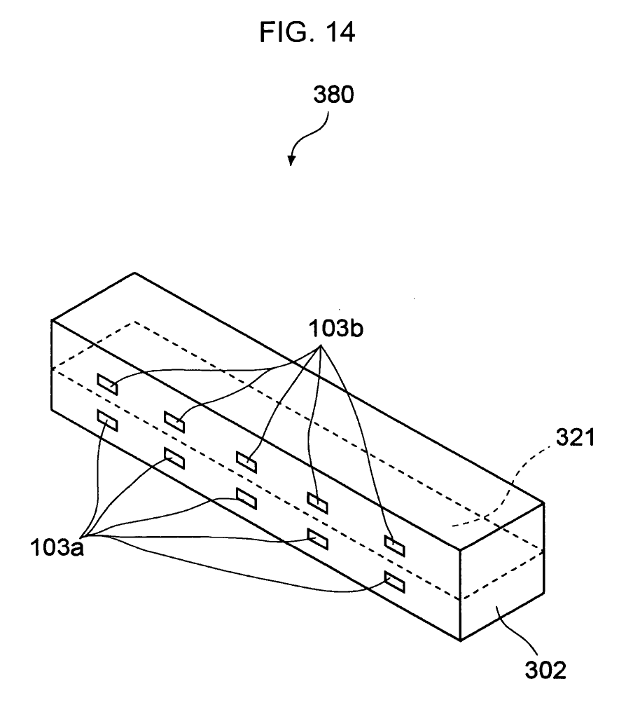

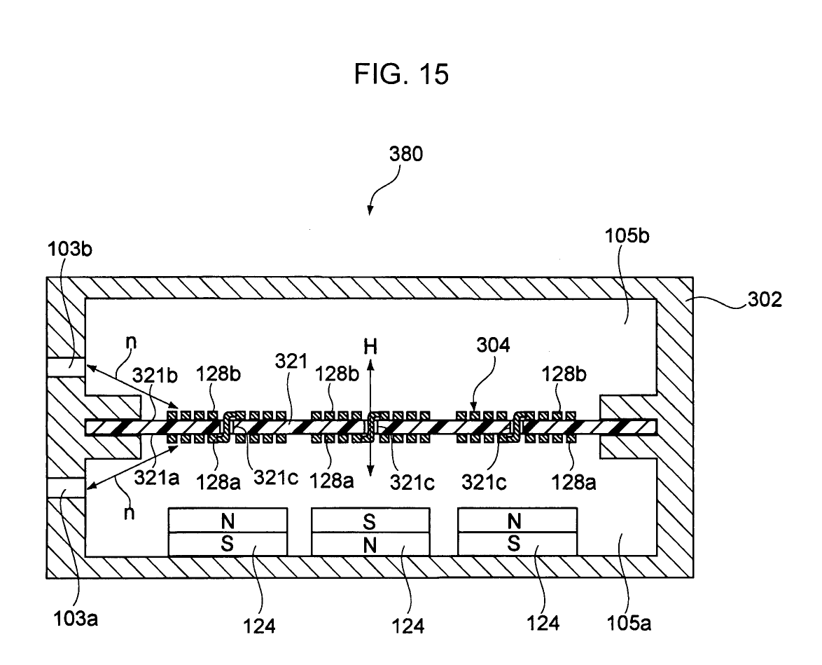

FIG. 14 is a perspective view illustrating a gas-injecting unit according to another embodiment, and FIG. 15 is a cross-sectional view of the gas-injecting unit. A gas-injecting unit 380 includes a housing 302 and a vibrating plate 321 disposed inside the housing 302 to partition the housing 302 into two chambers 105a and 105b. The chamber 105a communicates with the exterior of the housing 302 via openings 103a, whereas the chamber 105b communicates with the exterior of the housing 302 via openings 103b. The openings 103a and 103b are formed along the longitudinal direction of the housing 302.

The gas-injecting unit 380 can inject gas alternately from the openings 103a and 103b since the air pressures inside the chambers 105a and 105b alternately change by the vibration of a vibrator 304. As a result, the volume of injected gas can be increased compared with the case with one opening.

It is preferable that the volumes of the chambers 105a and 105b be substantially the same. A large difference in volume causes asymmetrical amplitude of the vibrator 304 due to the pressure resistance of the air in the smaller chamber, and the volume of vortexes injected from the smaller chamber is disadvantageously reduced.

Moreover, it is preferable that the distance n between the vibrator 304 and each opening 103a or each opening 103b be substantially the same such that the above-described aerodynamic characteristics become symmetrical in the chambers 105a and 105b. In particular, the shape of the housing 302 or the profiles of the openings 103a and 103b are preferably symmetrical with respect to the vibrator 304.

Furthermore, the distance j between one opening 103a and the respective opening 103b is preferably minimized. When the distance j is long, the vortexes generated in the vicinities of the opening 103a and the opening 103b are expanded, and the gas is not efficiently sent into the gas inlets of the fuel-cell unit (not shown). In order to efficiently send the gas, the total opening area of one opening 103a and the respective opening 103b may be smaller than that of one inlet of the fuel-cell unit opposing both the opening 103a and the opening 103b. Thus, the air injected from the two openings 103a and 103b can be efficiently sent into, for example, one inlet to enhance the power generation efficiency of the fuel-cell device.

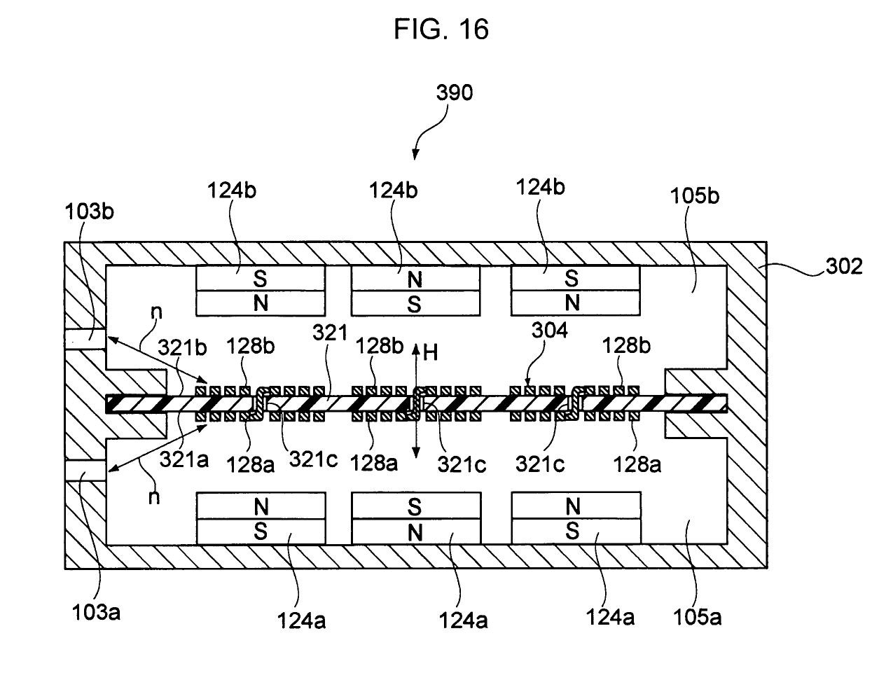

FIG. 16 is a cross-sectional view illustrating a gas-injecting unit according to another embodiment. A gas-injecting unit 390 has the same structure as that of the gas-injecting unit 380 shown in FIG. 15 except that the gas-injecting unit 390 further includes permanent magnets 124b opposing planar coils 128b in a chamber 105b. In this case, each of the permanent magnets 124b faces one permanent magnet 124a arranged in a chamber 105a such that the poles facing each other are homopolar. Thus, the electromagnetic force can be increased to enhance the conversion efficiency into the vibrational energy of a vibrator 304. In addition, due to the arrangement of the permanent magnets 124b in the chamber 105b, the volumes of the chamber 105a and the chamber 105b become equal, and the gas-injecting unit 390 becomes symmetrical with respect to the vibrator 304. Accordingly, the aerodynamic characteristics become symmetrical, and a constant volume of air is injected from openings 103a and openings 103b to the fuel-cell unit to improve the power generation efficiency.

The present invention is not limited to the above-described embodiments, and various modifications are permissible.

For example, in FIGS. 3 and 4, although the plurality of planar coils 128 is attached to the vibrator 104 of the gas-injecting unit 101, a single planar coil may be attached. Also, the number of planar coils is not limited, and may be larger or smaller than that in the embodiment described with reference to FIGS. 3 and 4. The number of planar coils can be changed as appropriate according to the size of the vibrating plate 121 or the size of the planar coils. Moreover, although the planar coils 128 are attached to the vibrating plate 121 on the surface adjacent to the chamber 105, they may be attached to the vibrating plate 121 on the surface facing the exterior of the housing.

Furthermore, the housings of the gas-injecting units according to the above-described embodiments may be partly or entirely composed of a magnetic material. Magnetic circuits can be formed of such a magnetic material so as to increase the electromagnetic force and to enhance the conversion efficiency into the vibrational energy of the vibrators. In this case, the magnetic material can be arranged in the vicinity of, for example, the permanent magnets.

In the above-described embodiments, the vibrators are vibrated by the coils and the permanent magnets, but piezoelectric elements may be used instead of the coils and the permanent magnets.

In FIGS. 15 and 16, the planar coils may be attached only to one side of the vibrating plate 321.

1. A fuel-cell device comprising:
a fuel-cell unit having a flow channel for circulating a predetermined gas; and
a mechanism disposed adjacent to the fuel-cell unit, the mechanism injecting the gas in the form of a pulsating flow.

2. The fuel-cell device according to claim 1, wherein
the gas injected from the mechanism is air.

3. The fuel-cell device according to claim 1, wherein
the mechanism comprises a housing having at least one opening, and a vibrator for injecting the gas contained inside the housing into the flow channel through the opening.

4. The fuel-cell device according to claim 3, wherein
the vibrator comprises a first surface facing the exterior of the housing and a second surface facing the interior of the housing.

5. The fuel-cell device according to claim 3, wherein
the housing comprises a plurality of chambers partitioned by the vibrator;
said at least one opening in the housing comprises a plurality of openings connecting the chambers with the exterior of the housing; and
the vibrator injects the gas contained inside the chambers through the openings.

6. The fuel-cell device according to claim 5, wherein
the chambers have substantially the same volumes; and
the spaces between the vibrator and each of the openings are substantially the same.

7. The fuel-cell device according to claim 3, wherein
the fuel-cell unit comprises an inlet for introducing the gas injected from the mechanism to the flow channel, the inlet facing the opening; and
the gap between the opening and the inlet is one time to ten times larger than the width of the opening.

8. The fuel-cell device according to claim 7, wherein
the gap between the opening and the inlet is two times to five times larger than the width of the opening.

9. The fuel-cell device according to claim 3, wherein
the fuel-cell unit comprises an inlet for introducing the gas injected from the mechanism to the flow channel, the inlet facing the opening; and
the opening area of the opening is smaller than that of the inlet.

10. The fuel-cell device according to claim 5, wherein
the fuel-cell unit comprises an inlet for introducing the gas injected from the mechanism to the flow channel, the inlet facing the openings; and
the total opening area of the openings is smaller than the opening area of the inlet.

11. The fuel-cell device according to claim 3, wherein
the vibrator comprises a vibrating plate having a first surface substantially perpendicular to the vibrating direction of the vibrator and a second surface substantially parallel to the first surface, and at least one coil attached to at least one of the first surface and the second surface; and
the mechanism comprises at least one permanent magnet opposing said at least one coil.

12. A gas-injecting unit comprising:
at least one permanent magnet;
a vibrating plate having a first region and a second region surrounding the first region, capable of injecting gas in the form of a pulsating flow generated by the pressure of the vibration when the vibrating plate vibrates;
at least one coil arranged in the first region; and
a supporting body supporting the permanent magnet and the vibrating plate such that the vibrating plate vibrates by the interaction between a magnetic field generated by the permanent magnet and that generated when the coil is energized.

13. The gas-injecting unit according to claim 12, wherein
the Young's modulus of the second region is lower than that of the first region.

14. The gas-injecting unit according to claim 13, wherein
the first region is mainly composed of a resin selected from an epoxy resin, a polyimide resin, a polyetherimide resin, and a polyethylene-terephthalate resin; and
the second region is mainly composed of butyl rubber.

15. The gas-injecting unit according to claim 12, wherein
the first region and the second region of the vibrating plate are composed of the same material; and
the second region is partially recessed in the same direction as the vibrating direction of the vibrator so as to form a groove.

16. The gas-injecting unit according to claim 15, wherein
the coil is of a planar type wound in a plane perpendicular to the vibrating direction of the vibrator; and
the groove is arranged in the plane in a helical fashion.

17. The gas-injecting unit according to claim 15, further comprising:
a lead wire electrically connected to the coil and detached from the gas-injecting unit.

18. The gas-injecting unit according to claim 12, wherein
the vibrating plate comprises a first surface substantially perpendicular to the vibrating direction of the vibrating plate, a second surface substantially parallel to the first surface, and a hole extending from the first surface to the second surface; and
said at least one coil comprises a first coil arranged in the first surface and a second coil electrically connected to the first coil through the hole.

19. The gas-injecting unit according to claim 18, wherein
said at least one permanent magnet comprises a first permanent magnet opposing the first coil, and a second permanent magnet opposing the second coil and facing the first permanent magnet having the same pole.

20. The gas-injecting unit according to claim 12, wherein
said at least one permanent magnet comprises a plurality of permanent magnets arranged along a plane substantially perpendicular to the vibrating direction of the vibrating plate such that the directions of magnetic fields generated at two adjacent permanent magnets are opposite; and
said at least one coil comprises a plurality of coils arranged corresponding to the permanent magnets.

21. The gas-injecting unit according to claim 12, wherein
the supporting body contains a magnetic material in the vicinity of the permanent magnet.

22. The gas-injecting unit according to claim 12, wherein
the supporting body is a housing having at least one opening; and
the vibrating plate injects the gas contained inside the housing through the opening when the vibrating plate vibrates.

23. The gas-injecting unit according to claim 22, wherein
the housing comprises a plurality of chambers partitioned by the vibrating plate;
said at least one opening comprises a plurality of openings connecting the chambers with the exterior of the housing; and
the vibrating plate injects the gas contained inside the chambers through the openings.

24. A method for generating power using a fuel-cell device having a flow channel for circulating a predetermined gas, comprising the steps of:
injecting the gas in the form of a pulsating flow into the flow channel; and
generating power through the use of the gas circulating in the flow channel.
